(19) United States
(12) Patent Application Publication
(10) Pub. No.: US 2023/0410882 A1
(43) Pub. Date: Dec. 21, 2023

(54) DEFENSE AGAINST ROW HAMMER ATTACKS

(71) Applicant: QUALCOMM Incorporated, San Diego, CA (US)

(72) Inventors: Akash VERMA, Bangalore (IN); Victor VAN DER VEEN, Leusden (NL); Joona Verneri KANNISTO, Salo, FL (US); Marcel SELHORST, Zeuthen (DE)

(21) Appl. No.: 17/842,606

(22) Filed: Jun. 16, 2022

(51) Int. Cl. G11C 11/4078; G11C 11/408; G11C 11/406

(52) U.S. Cl. CPC G11C 11/4078; G11C 11/4087; G11C 11/40615; G11C 11/40618

(57) ABSTRACT

The present disclosure generally relates to techniques for defending against row hammer attacks. Some aspects of the present disclosure include systems and techniques for defending against row hammer attacks using dynamic assignment of guard rows. One example computing device for memory protection generally includes at least one memory and one or more processors coupled to the at least one memory and configured to: receive a first memory assignment for a service; determine, in response to receiving the first memory assignment, that the service is associated with a type of data; assign guard rows adjacent to a memory subset to protect the memory subset based on the determination; and dedicate at least a portion of the memory subset for storage of data for the service.

### FIELD

The present disclosure generally relates to techniques for defending against row hammer attacks. Some aspects of the present disclosure include systems and techniques for defending against row hammer attacks using dynamic assignment of guard rows.

### BACKGROUND

In dynamic random-access memory (DRAM), memory cells interact electrically between themselves by leaking their charges. For example, an access attempt to memory on one row may result in charge leakage of a memory cell on an adjacent row. A row hammer attack is a security exploit where repeated access attempts are made to one row to change the contents of nearby memory rows. This issue is exacerbated by the high cell density in modern DRAM. The row hammer attack may be triggered by specially crafted memory access patterns that rapidly activate the same memory rows numerous times.

### SUMMARY

Certain aspects of the present disclosure provide a computing device. The computing device generally includes at least one memory and one or more processors coupled to the at least one memory and configured to: receive a first memory assignment for a service; determine, in response to receiving the first memory assignment, that the service is associated with a type of data; assign guard rows adjacent to a memory subset to protect the memory subset based on the determination; and dedicate at least a portion of the memory subset for storage of data for the service.

Another example includes a method for memory protection. The method generally includes: receiving a first memory assignment for a service; determining, in response to receiving the first memory assignment, that the service is associated with a type of data; assigning guard rows adjacent to a memory subset to protect the memory subset based on the determination; and dedicating at least a portion of the memory subset for storage of data for the service.

Another example includes a computer-readable medium having instructions stored thereon, that when executed by one or more processors, cause the one or more processors to: receive a first memory assignment for a service; determine, in response to receiving the first memory assignment, that the service is associated with a type of data; assign guard rows adjacent to a memory subset to protect the memory subset based on the determination; and dedicate at least a portion of the memory subset for storage of data for the service.

Another example includes an apparatus for memory protection. The apparatus generally includes means for receiving a first memory assignment for a service; means for determining, in response to receiving the first memory assignment, that the service is associated with a type of data; means for assigning guard rows adjacent to a memory subset to protect the memory subset based on the determination; and means for dedicating at least a portion of the memory subset for storage of data for the service.

In some aspects, one or more of the apparatuses described above is, can be part of, or can include a vehicle or component (e.g., implemented in hardware and/or software) or system of a vehicle, a mobile device (e.g., a mobile telephone or so-called “smart phone” or other mobile device), an Internet-of-Things (IoT) device, an extended reality (XR) device (e.g., a virtual reality (VR) device, an augmented reality (AR) device, or a mixed reality (MR) device), a wearable device, a personal computer, a laptop computer, a tablet computer, a server computer, a robotics device or system, an aviation system, or other device. In some aspects, one or more of the apparatuses includes an image sensor (e.g., a camera) or multiple image sensors (e.g., multiple cameras) for capturing one or more images. In some aspects, one or more of the apparatuses includes one or more displays for displaying one or more images, notifications, and/or other displayable data. In some aspects, one or more of the apparatuses includes one or more speakers, one or more light-emitting devices, and/or one or more microphones. In some aspects, one or more of the apparatuses described above can include one or more sensors. For instance, the one or more sensors can include at least one of a light-based sensor (e.g., a LIDAR sensor, a radar sensor, etc.), an audio sensor, a motion sensor, a temperature sensor, a humidity sensor, an image sensor, an accelerometer, a gyroscope, a pressure sensor, a touch sensor, and a magnetometer. In some cases, the one or more sensors can be used for determining a location of the apparatuses, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example computing device, in accordance with some examples.

FIG. 2 is a diagram illustrating an example architecture for implementing virtual machines.

FIGS. 3A-3D are diagrams illustrating an example memory bank used to implement virtual machines.

FIG. 3E is a diagram illustrating an example of a memory bank having guard rows to protect sensitive memory cells, in accordance with certain aspects of the present disclosure.

FIGS. 3F-3G are diagrams illustrating examples of memory subsets with spatial isolation using guard rows, in accordance with certain aspects of the present disclosure.

FIG. 4 is a diagram illustrating an example of guard rows implemented between memory used for different services, in accordance with certain aspects of the present disclosure.

FIG. 5 is a flow diagram illustrating example operations for memory protection, in accordance with certain aspects of the present disclosure.

FIG. 6 is a call flow diagram illustrating example operations for memory mapping, in accordance with certain aspects of the present disclosure.

FIG. 7 is a diagram illustrating an example of row mapping schemes, in accordance with certain aspects of the present disclosure.

FIGS. 8A and 8B are diagrams illustrating assignment of guard rows for memory chunks based on a mapping scheme, in accordance with certain aspects of the present disclosure.

FIG. 9 is a flow diagram illustrating an example process for memory protection, in accordance with certain aspects of the present disclosure.

FIG. 10 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As described herein, a row hammer attack is a security exploit where repeated access attempts are made to one row to change the contents of nearby memory rows. Guard rows may be used to protect portions of memory from row hammer attacks. A guard row is a row of memory (or a portion of a row of memory) that is unutilized (or user unaccessible for read or write attempts) and that provides spatial isolation between one portion of memory and another, preventing (or at least reducing the likelihood of) a row hammer attack. However, assigning guard rows to memory in a static manner may result in excess memory utilization or insufficient row hammer protection. For instance, it may not be necessary to provide row hammer protection with guard rows for all memory because some memory may not store data sensitive to exploitation. Therefore, static assignment of guard rows to generate protected memory slots and assignment of memory to the protected memory slots without analysis of the type of memory being assigned may result in either too many guard rows being used resulting in excess memory utilization or certain types of memory that greatly benefit from row hammer protection not being protected due to lack of availability of protected memory.

Systems, apparatuses, processes (also referred to as methods), and computer-readable media (collectively referred to herein as “systems and techniques”) are described herein for protecting memory against row hammer attacks using dynamic allocation of guard rows. Memory assignments for a service may be analyzed to determine whether the memory assignment is sensitive to row hammer attacks. For example, it may be determined whether the data for the service is for a particular type of data (e.g., sensitive or important data for a specific service, such as financial services, personal data, etc.). If the memory assignment is sensitive, then guard rows may be used to protect the memory assignment from row hammer attacks. By identifying and implementing guard rows for sensitive memory assignments, row hammer protection may be implemented in a dynamic manner, reducing the memory utilization cost that would otherwise be associated with implementing guard rows in a static manner.

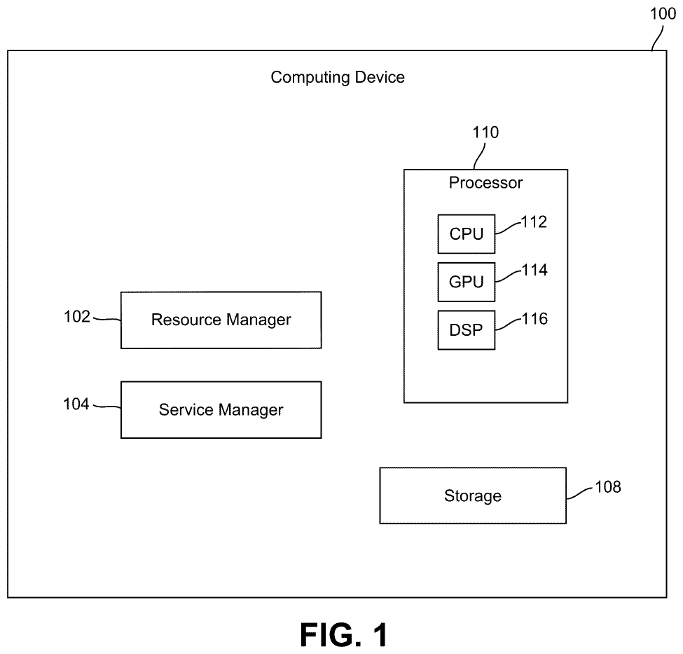

FIG. 1 is a diagram illustrating an example computing device 100, in accordance with some examples. In the example shown, the computing device 100 may include storage 108, processor 110, and memory controller 112. The storage 108 can include any storage device(s) for storing data. The storage 108 can store data from any of the components of the computing device 100.

The storage 108 may be a dynamic random access memory (DRAM) or other type of storage. The storage 108 may be subject to attacks aimed at changing data stored in the storage 108 (e.g., data stored in DRAM or other storage). In one illustrative example, a row hammer attack may be used to change bit states in the DRAM, as described in more detail herein. While examples are described herein using DRAM as an illustrative example of storage or memory, the techniques described herein may apply to other types of storage or memory, such as other types of RAM such as synchronous dynamic random access memory (SDRAM) and/or non-volatile random access memory (NVRAM), read-only memory (ROM), electrically erasable programmable read-only memory (EEPROM), cache memory, FLASH memory, magnetic or optical data storage media, or other type of storage or memory.

In some implementations, the processor 110 can include a central processing unit (CPU) 112, a graphics processing unit (GPU) 114, a digital signal processor (DSP) 116, any combination thereof, or other type of processor. As shown, computing device 100 may include a service manager component 104 (e.g., a hypervisor component) which may manage one or more services such as virtual machines (VMs) that may operate on the computing device 100. While various aspects and examples are described herein with respect to VMs as an example of a service, the systems and techniques apply to any type of service. In some aspects, the computing device 100 also includes a resource manager 102 which may manage memory resources for various services, such as VMs. In some aspects, resource manager 102 and hypervisor component 104 may be implemented as part of the processor 110 and/or implemented as instructions in storage 108. The resource manager 102 and hypervisor component 104 may be implemented in hardware, software, or a combination of hardware and software. In some aspects, the resource manager 102 and the hypervisor component 104 may be implemented by or in the same hardware, software, or combination of hardware and software (e.g., by a same processor). In some aspects, the resource manager 102 and the hypervisor component 104 may be implemented by or in separate hardware, software, or combination of hardware and software.

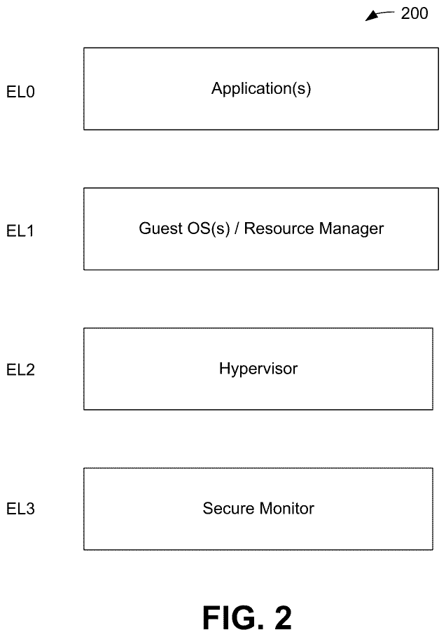

FIG. 2 illustrates an example architecture 200 for implementing VMs (e.g., which may be managed by the hypervisor component 104 of the computing device 100 of FIG. 1). The architecture 200 associates exception levels with software execution privileges and defines a set of four exception levels (EL0, EL1, EL2 and EL3). EL0 is the lowest privileged execution level and EL3 is the highest privileged execution level. EL0 is the level at which normal applications run (e.g., in userspace). EL3 is the only privilege level in which a security state associated with the execution can be changed. Software running at EL3 is known as a secure monitor. EL2 provides a non-secure state of execution and may be used for running a Hypervisor (e.g., for virtualization). Operating system kernels may run at the EL1 exception level. A hypervisor is software that creates and runs VMs, as described herein. A hypervisor, sometimes called a virtual machine monitor (VMM), isolates the hypervisor operating system and resources from the virtual machines and enables the creation and management of VMs. VMs may use dynamic memory, which may be managed by a resource manager (e.g., resource manager 102) implemented at EL1. Multiple VMs may be implemented, which may be untrusting of each other. For example, one VM may be used to implement a row hammer attack on another VM if the memory allocations of the VMs are not spatially isolated. There may also be a mix of sensitive and non-sensitive VMs. In some scenarios, one VM may be used to perform a row hammer attack on another VM, or there may be hammering within VMs, such as hammering via userspace applications to the kernel space, or hammering between userspace applications.

EL2 has distinct address space objects for VMs. Memory extensions are mapped to address spaces, and page tables for VMs are mapped to address spaces. From a resource manager perspective, memory operations happen through memory parcels, which may be created and mapped into VMs. VMs may use memory that they accept via a memory accept function implemented for lent memory (e.g., memory lent by one VM to another), donated memory (e.g., donated by one VM to another), or shared memory (e.g., memory shared by VMs). In some aspects, guard rows may be assigned (e.g., created) for hypervisor memory during hypervisor boot. The hypervisor memory may be physically contiguous memory (e.g., for efficient protection using guard rows as described in more detail herein). The architecture 200 is provided as an example to facilitate understanding of exception levels. The aspects of the present disclosure are applicable to any suitable architecture, such as an architecture for a TrustZone (e.g., also referred to as a Secure world architecture).

In some cases, DRAM hammering attacks (e.g., row hammer attacks) leverage a hardware bug (or side effect) of memory cells electrically interacting and leaking charge. For example, contents in some rows of memory may be changed without an attacker (e.g., a hacker) directly accessing those rows. Rather, the attacker may attempt to change a digital state of a memory cell in one row by directing repeated access read attempts to one or more nearby rows (e.g., an adjacent row) of the memory. The attack may be exploited to implement privilege escalation and remote code execution attacks. Some mitigation tactics against such hammering attacks involve changes at the hardware level (e.g., such as adding extra hardware for encryption and authentication), whereas others are dependent on some heuristics to decide guide policy decisions. Some techniques for guarding against row hammer attacks involve the implementation of guard rows (e.g., spatial isolation of memory regions) in a static manner, which can be costly with regard to memory utilization.

Certain aspects of the present disclosure provide techniques for spatial isolation of physical rows in storage or memory (e.g., DRAM or other storage or memory) banks as a software mitigation in dynamic and a cost-effective manner that can be reused across sensitive components on a computing device or system (e.g., for TrustZone, Hypervisor, Sensitive Virtual Machines and other sensitive subsystems), such as a mobile device, extended reality (XR) device, vehicle computing system, or other device or system. At a high level, certain aspects provide mitigation techniques that involve selectively implementing guard rows in a physical memory bank (e.g., to avoid overuse of guard rows that would result in a high memory area penalty). For example, if adjacent rows belong to the same security domain, no guard rows may be implemented between those rows. Rather, guard rows may be implemented at the boundaries of rows being used by a sensitive component (e.g., a sensitive VM), providing spatial isolation between the rows being used by the sensitive component and other rows that may be used to implement the row hammer attack. Inserting memory holes (e.g., guard rows) in physical addresses may involve assigning guard rows in banks with one guard row on each side of the physical addresses to prevent (or at least reduce the likelihood of) successful hammering attacks. For statically carved out regions, the placement of guard rows may be predetermined and may be inserted during boot-time.

For dynamic memory that is used by sensitive components (such a VM or hypervisor), the memory mapping/management code responsible for the given component may be changed dynamically. For example, for a VM, memory management code would be in a hypervisor because the hypervisor controls the virtual address (VA) to physical address (PA) mappings for VMs. The memory manager (e.g., hypervisor component 104) may identify if a chunk of memory is being mapped to a sensitive component. If so, and if the mapping is the first mapping request for that component, the memory manager may create a physically contiguous memory chunk and place guard rows at both ends of the chunk of memory for row hammer protection. In some cases, the size of the memory chunk that is created may be set dynamically based on the VM's memory specifications. Subsequent mapping requests to the components may be served from the created memory chunk that is now protected by guard rows. If the memory chunk gets filled (e.g., becomes fully utilized), another memory chunk may be created with two more guard rows for protection. The memory manager may keep track of the mapping data for a particular memory chunk and the sensitive component that owns the memory chunk. This dynamic scheme reduces the memory cost of an isolation-based row hammer protection scheme, without usage of static carveouts and associated wastage, and may be transparent to the components that are being protected. For example, implementing guard rows using a dynamic approach as described herein may save about 20 MB of memory as compared to assignment of guard rows in a static manner.

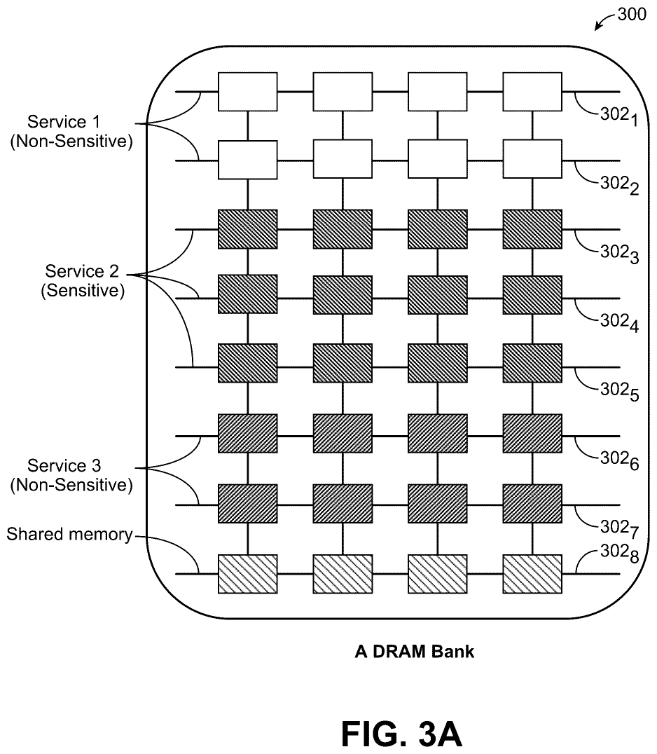

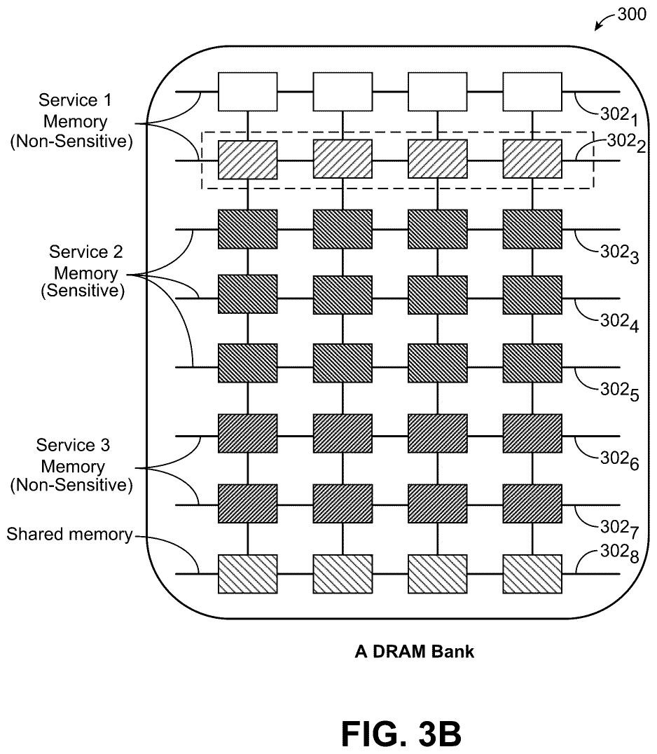

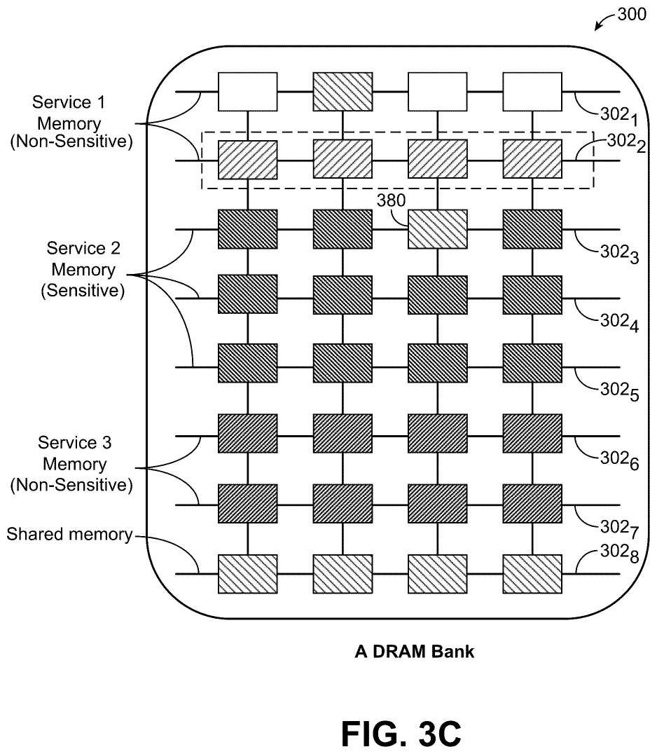

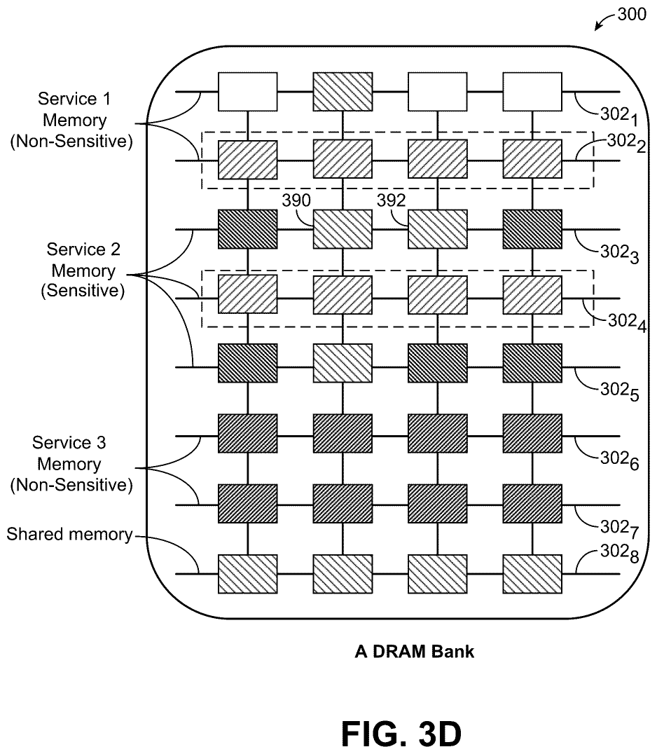

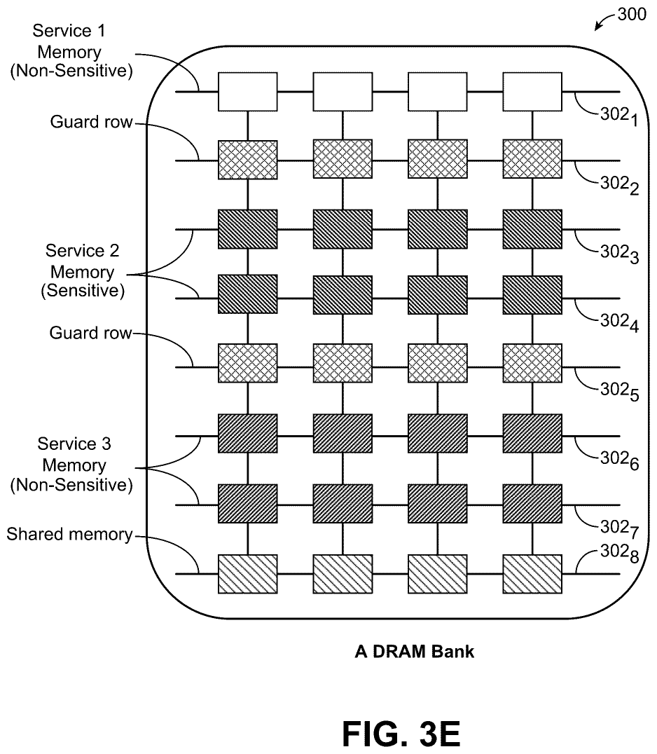

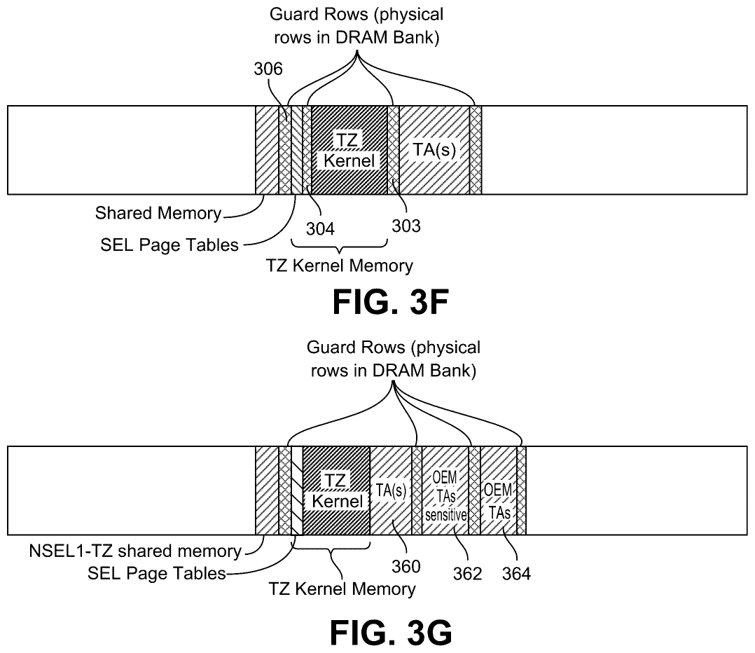

FIGS. 3A-3D illustrate a memory bank 300 (e.g., DRAM bank) used to implement virtual machines. As shown in FIG. 3A, rows 302₁ and 302₂ may be used for a first service (e.g., a first VM, which can be referred to as VM1, a first TrustZone, or other service), which may be a non-sensitive service (e.g., a non-sensitive VM). Rows 302₃, 302₄, 302₅ may be for a second service (e.g., VM2, a second TrustZone, etc.), which may be a sensitive service (e.g., a VM for financial services), and rows 302₆, 302₇ may be for a third service, which may be a non-sensitive service (e.g., VM3). As shown, row 302₈ may be shared memory, which is described in more detail herein. As shown in FIG. 3B, access attempts may be made to row 302₂ to implement a row hammer attack on the memory subset of service 2 which may be storing sensitive data. As a result of the access attempts, the data stored in at least memory cell 380 on row 302₃ may be changed, as shown in FIG. 3C.

In some cases, a row hammer attack may be carried out using two adjacent rows. For example, as shown in FIG. 3D, access attempts may be made to rows 303₄ and 302₂ mapped for service 1 (e.g., VM1), resulting in a change of state of memory cells 390, 392 on row 302₃ mapped for service 2 (sensitive VM2). Certain aspects of the present disclosure implement guard rows to protect memory subsets mapped to sensitive services, such as a financial service VM.

FIG. 3E is a diagram illustrating an example of a memory bank 300 (e.g., DRAM bank) having guard rows to protect sensitive memory cells, in accordance with certain aspects of the present disclosure. As shown, the memory bank 300 includes multiple rows 302₁ to 302₈ (collectively referred to as rows 302). Rows 302 may be used to store data associated with various functions, such as the implementation of virtual machines. For instance, row 302₁ may be used for a first non-sensitive VM (VM1) which may not be a target for row hammer attacks. On the other hand, rows 302₃ and 302₄ may be mapped to a second VM (VM2) which may be a target for row hammer attacks. As shown, rows 302₂ and 302₅ may be mapped as guard rows above and below the memory mapped to VM2. A guard row may be any row that is user inaccessible (e.g., a row that a user or hacker does not have direct or indirect access to). Without access to read or write to guard rows 302₂ and 302₅, a hacker may be unable to perform repeated access attempts to the rows adjacent to the sensitive rows 302₃ and 302₄ in an attempt to change the digital state of the sensitive rows.

In some aspects, the memory manager may identify certain types of memory as sensitive and implement guard rows to protect the memory. For example, guard rows may be used for the protection of TrustZone (TZ) secure memory (e.g., all memory including page tables), trusted application (TA) memory (e.g., or at least a subset of TA memory that opts for protection), Hypervisor memory (e.g., entire EL2 memory), and private memory owned by sensitive VMs. TrustZone is a hardware mechanism that breaks an execution environment into secure and non-secure memory, peripherals, and functions.

FIGS. 3F-3G illustrate carve-outs with spatial isolation using guard rows, in accordance with certain aspects of the present disclosure. As shown in FIG. 3F, physical isolation of TZ and TA memory may be implemented using a hole (e.g., one guard row 303 in the memory bank). For example, the guard row 302 may be implemented between a TZ kernel and one or more TAs, as shown. Moreover, a guard row 304 may be implemented between the TZ kernel and page tables for TZ and a guard row 306 may be implemented between page tables and shared memory. Since only one TA may be executed at a time, inter-TA hammering protection may not be implemented for memory. Individual page table entries (PTEs) may not be spatially isolated, giving an opportunity for TAs to hammer the page tables through a memory management unit. For example, the TA may flush the translation lookaside buffers (TLBs) and trigger a large number of page table accesses. A TLB is a memory cache that stores the recent translations of virtual memory to physical memory. As shown in FIG. 3G, mini carve-outs for buckets of TAs may be carried out. For example, a guard row may be implemented between TA 360 and TA 362 (e.g., an original equipment manufacturer (OEM) TA that is sensitive), and a guard row may be implemented between TA 362 and another OEM TA 364, as shown.

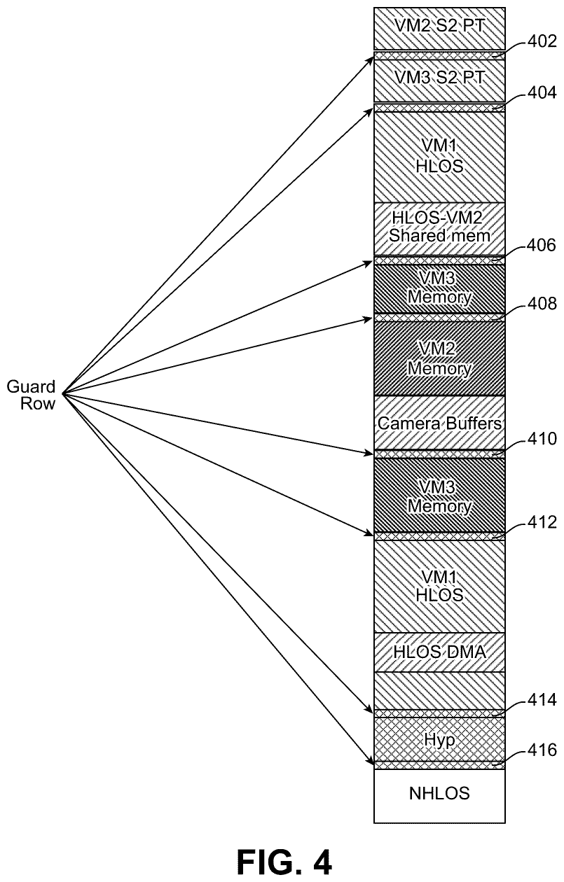

FIG. 4 illustrates guard rows implemented between memory subsets used for different services, in accordance with certain aspects of the present disclosure. As shown, guard rows are implemented to protect various memory regions. Memory for a VM (e.g., VM3) may be sensitive to attacks, and thus guard rows 410 and 412 (or guard rows 406, 408) are implemented to protect the memory for VM3, as shown.

Similarly, the VM3 page tables (e.g., second level (S2) page tables) may be protected using guard rows (e.g., guard rows 402, 404). Other VM memory regions (e.g., VM2 memory), including shared memory, may be non-sensitive to attacks (e.g., may have non-sensitive data that may not warrant protection). For example, the memory region for VM1 high-level operating system (HLOS) may be implemented adjacent to the memory region for HLOS for VM2 shared memory, without guard rows between the memory regions. As shown, memory used for the hypervisor (labeled “Hyp”) may be sensitive and protected using guard rows 414, 416.

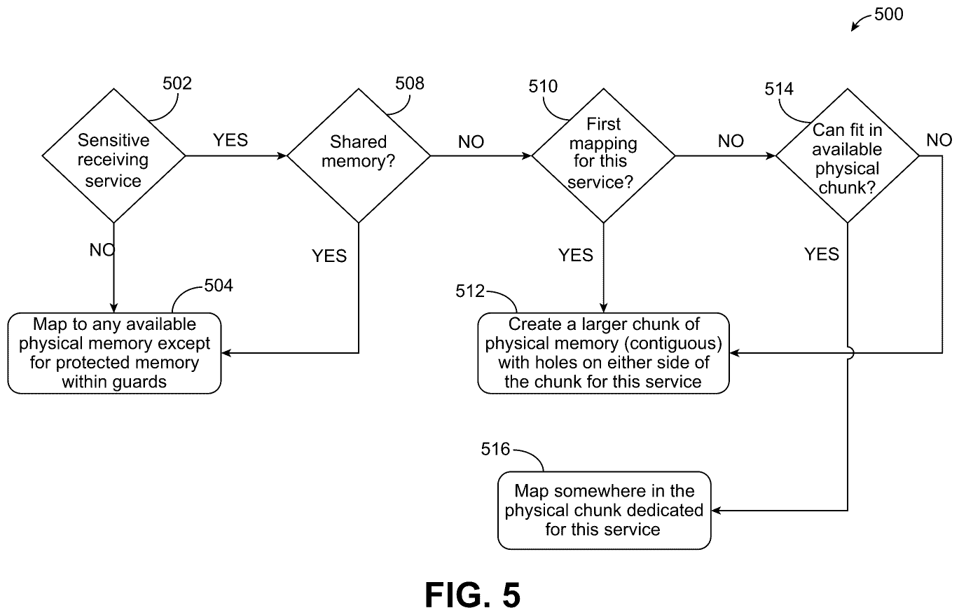

FIG. 5 is a flow diagram illustrating example operations 500 for memory protection, in accordance with certain aspects of the present disclosure. Each service (e.g., VM, TrustZone (TZ), or other service) may be associated with attributes which may indicate the sensitivity of the service with regards to row hammer attacks. At block 502, a memory manager (e.g., computing device) may determine whether memory assignment accepted via a memory accept operation is sensitive. For example, an original equipment manufacturer (OEM) may push a service onto a device, such as a payment VM, and the OEM may indicate whether the service is sensitive. If not sensitive, then guard row protection may not be implemented for the memory, and at block 504, the memory for the VM may be mapped to any available physical memory.

If the memory manager determines that the service is sensitive, the computing device may, at block 508, determine whether the service is accepting shared memory. If so, no extra protection may be implemented for the memory. Shared memory is memory that is shared across services. Shared memory is still mapped to (e.g., shared with) other services, so shared memory would not be used for sensitive operations. When a memory accept operation is performed, the memory manager determines whether the memory is being donated (e.g., by another service such as another VM), whether the memory is being lent by another service, or if another service is sharing that memory. If memory is lent or donated, the memory may be accepted and used privately by the service. But if shared, the shared memory will not unmap with the other entity (e.g., other service such as a VM), and thus, is not private. As a result, it may be assumed that the memory is not sensitive and may be implemented without guard row protection.

If the memory is determined to be sensitive and is not shared memory, the memory manager may determine whether this is the first mapping for the service at block 510. If so, at block 512, the memory manager may create a chunk of physical memory (e.g., contiguous memory) with guard rows on either side of the memory chunk for protection against row hammer attacks. At block 516, the memory for the service may be mapped somewhere within the physical memory chunk that was created and dedicated for the service. If at block 510, the memory manager determines that this is not the first mapping of a memory assignment for this service (e.g., a physical memory chunk has already been created and dedicated to the service), then at block 514, the memory manager may determine whether the memory assignment for the service will fit into the chunk of physical memory previously created for the service. If so, at block 516, the memory manager maps the memory assignment to the created chunk of memory. If the memory assignment for the service does not fit into the previously created chunk of memory, a new chunk of memory may be created at block 512 for the memory.

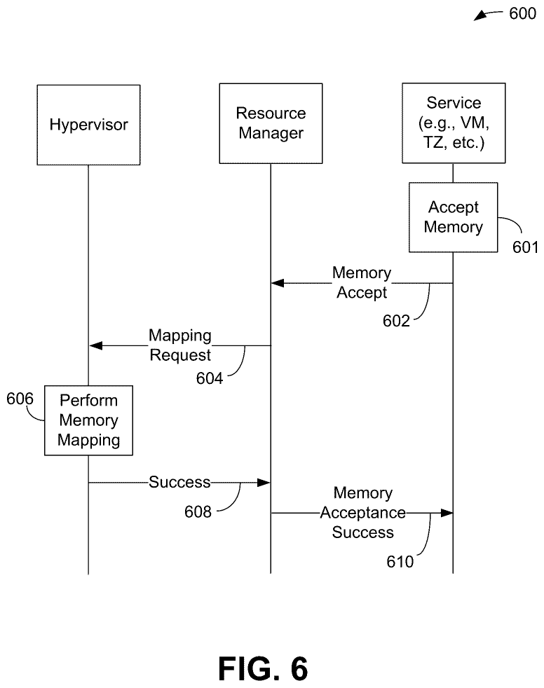

FIG. 6 is a call flow diagram illustrating example operations 600 for memory mapping for a virtual machine (VM) (as an illustrative example of a service described herein), in accordance with certain aspects of the present disclosure. As shown, at block 601, a VM may accept a memory assignment. As an example, the memory assignment may refer to a portion of memory which may be lent or donated to the VM by another VM. The VM may then send an indication 602 of memory assignment acceptance to a resource manager. In turn, the resource manager may send a mapping request 604 to the hypervisor.

At block 606, the hypervisor may map the memory in a manner to protect the memory assignment for the VM from row hammer attacks. For example, the hypervisor may perform the operations described with respect to FIG. 5 to map the memory for the VM to a chunk of physical memory that is protected by guard rows, as described herein. Once mapped, the hypervisor may send a success indication 608 to the resource manager, which in turn sends a memory acceptance success indication 610 to the VM, as shown.

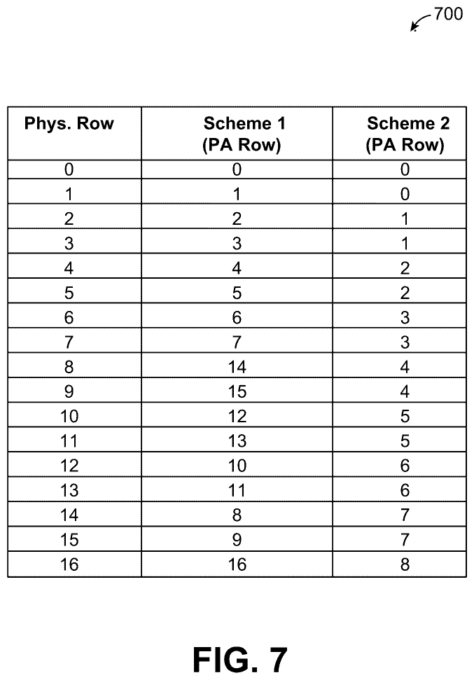

FIG. 7 is a diagram 700 illustrating illustrative examples of row mapping schemes. Depending on specific implementations associated with usage of memory, different row mapping schemes may be used, as shown. The computing device 100 (e.g., the hypervisor component 104) may refer to a row mapping scheme and assign guard rows in a virtual space to properly map to a physical space. As one illustrative example, for mapping scheme 1, in sixteen physical address (PA) rows, the first eight rows may be mapped as is to physical rows. For example, PA row one may be mapped to physical row one, PA row two may be mapped to physical row two, and so on. Yet the mapping between the PA rows and the next eight physical rows may be shifted following a known scheme, as shown. As another example, mapping scheme 2 may map two rows in the PA space to a single physical row in DRAM, as shown. In some aspects, the mapping of guard rows for row hammer protection may be based on the mappings of the PA rows to physical rows in DRAM.

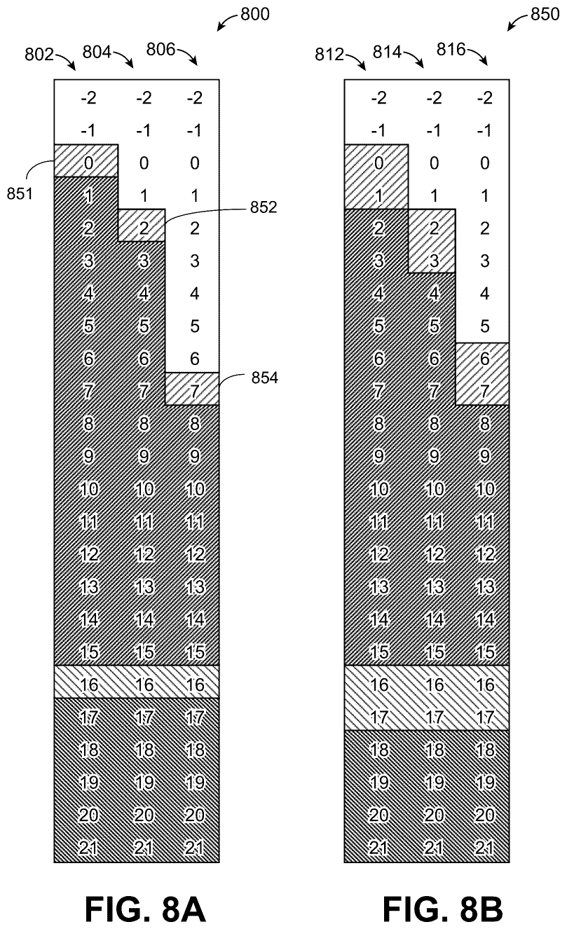

FIG. 8A is a diagram 800 illustrating the assignment of guard rows for a memory chunk based on a mapping scheme, in accordance with certain aspects of the present disclosure. FIG. 8A shows twenty-three rows of memory (e.g., starting from row-2 to row 21) across three columns 802, 804, 806 of memory. For mapping scheme 1, chunks of memory assigned for secure storage may start in the first eight rows (e.g., rows 0-7) of a 16-row chunk in DRAM and end at the 16^{th} row, as shown. For example, in columns 802, 804, 806, a guard row may be implemented at row 0 (corresponding to the first row in the diagram 800), row 2, and row 7 due to the mapping scheme, respectively, and another guard row may be implemented at row 16. For instance, physical address (PA) memory locations 851, 852, 854 may be unused and mapped to a single physical row of memory, in effect implementing a guard row in the physical space of memory. Therefore, the mapping from the virtual PA space (e.g., PA rows) to the physical space (e.g., physical rows) is taken into account when assigning particular PA memory locations as unused memory to implement a physical row of memory as a guard row for row hammer protection. FIG. 8B is a diagram 850 illustrating the assignment of guard rows for a memory chunk based on mapping scheme 2, in accordance with certain aspects of the present disclosure. As shown in FIG. 8B, due to mapping scheme 2 as described with respect to FIG. 7, the first two rows in the allocation may be guard rows and the first two rows in the next memory chunk allocation may be guard rows. For example, on column 812, a guard row is implemented at rows 0 and 1, on column 814, a guard row is implemented at rows 2 and 3, and on column 816, a guard row is implemented at rows 6 and 7. Two guard rows are also implemented at rows 16 and 17, as shown.

In some examples, a hypervisor may track where the guard rows are inserted to save on extra guard rows if a neighboring chunk also needs protection. For example, one guard row may be common between two adjacent memory chunks such that three guard rows can be used for the protection of two memory chunks instead of four guard rows.

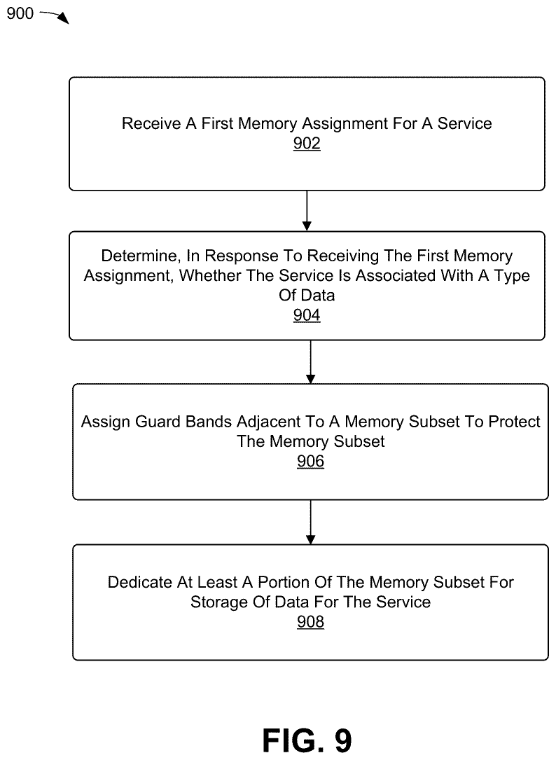

FIG. 9 is a flow diagram illustrating an example process 900 for memory protection, in accordance with certain aspects of the present disclosure. The operations of process 900 may be performed by a computing device (e.g., computing device 100). For example, the process 900 may be performed by a memory manager, such as the hypervisor component 104 of computing device 100.

At block 902, the computing device may receive a first memory assignment for a service (e.g., implementing a VM). At block 904, the computing device may determine, in response to receiving the first memory assignment, whether the service is associated with a type of data (e.g., sensitive or important data associated with the service, such as personal data, financial data, or other type of sensitive or important data).

At block 906, the computing device may assign guard rows adjacent to a memory subset to protect the memory subset. Each of the guard rows may include at least a portion of a row of memory that is user unaccessable. For example, each of the guard rows may include at least a portion of a row of memory that is not assigned for data storage for any service. Assigning the guard rows may include assigning at least a portion of a first row of a memory as a first guard row, and assigning at least a portion of a second row of the memory as a second guard row. The memory subset may include memory cells between the first guard row and the second guard row. In some aspects, the computing device may identify the memory subset and the guard rows based on a mapping between a physical address associated with the service and physical memory rows.

In some aspects, the computing device may identify whether the first memory assignment is associated with memory shared with another service. The memory subset may be protected based on the identification (e.g., may be protected if the first memory assignment is not shared with another service).

At block 908, the computing device may dedicate at least a portion of the memory subset for storage of data for the service. In some aspects, only the portion of the memory subset may be dedicated for storage of data for the service. The computing device may receive a second memory assignment for the service, determine whether the memory subset can accommodate storage of data for the second memory assignment, and dedicate another portion of the memory subset for the second memory assignment.

Certain aspects of the present disclosure provide a software mitigation technique for row hammer attacks that works on dynamic memory allocations and does not involve any static carve-outs or memory maps to be defined for a system on a chip (SoC). The row hammer mitigation technique may be independent of DRAM vendors and hardware blocks that may vary across SoCs, as described. Although based on spatial isolation, the techniques described herein capture how memory wastage in guard rows can be reduced practically with little to no impact on use cases and degrading the effectiveness of row hammer attack security.

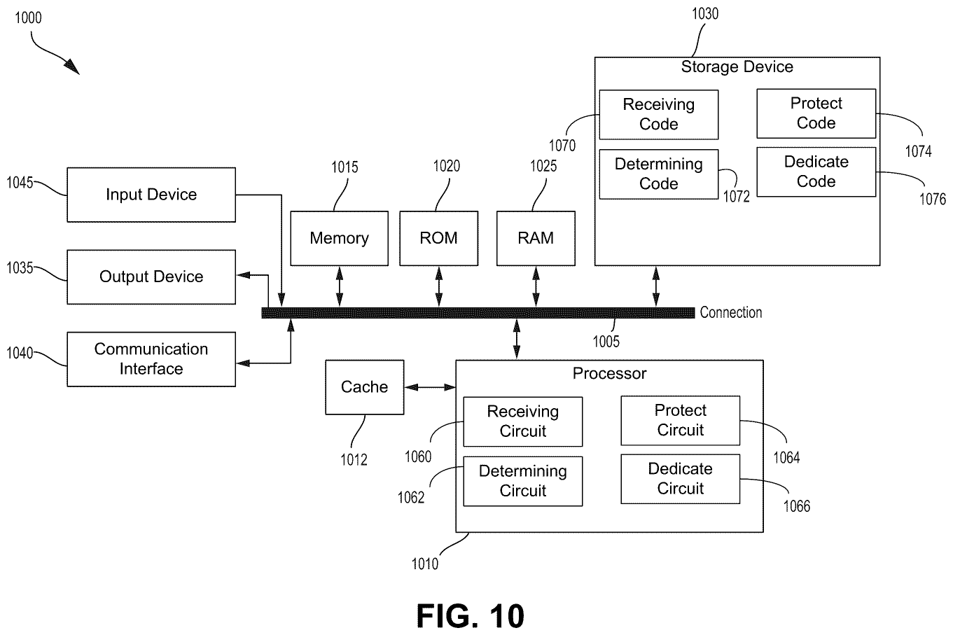

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service. In some aspects, code stored in storage device 1030 may be configured to control processor 1010 to perform operations described herein. In some aspects, the processor 1010 may be a special-purpose processor where instructions or circuitry are incorporated into the actual processor design to perform the operations described herein. Processor 1010 may essentially be a completely self-contained computing system, containing multiple cores or processors, a bus, memory controller, cache, etc. A multi-core processor may be symmetric or asymmetric. The processor 1010 may include circuit 1060 for receiving, circuit 1062 for determining, circuit 1064 for protecting, and circuit 1066 for dedicating.

The storage device 1030 may store code which, when executed by the processors 1010, performs the operations described herein. For example, the storage device 1030 may include code 1070 for receiving, code 1072 for determining, code 1074 for protecting, and code 1076 for dedicating.

To enable user interaction, computing system 1000 includes an input device 1045, which can represent any number of input mechanisms, such as a microphone for speech, a camera for generating images or video, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” and “at least one of A or B” means A, B, or A and B. In another example, claim language reciting “at least one of A, B, and C” and “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” and “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. A computing device, comprising: at least one memory; and one or more processors coupled to the at least one memory and configured to: receive a first memory assignment for a service; determine, in response to receiving the first memory assignment, that the service is associated with a type of data; assign guard rows adjacent to a memory subset to protect the memory subset based on the determination; and dedicate at least a portion of the memory subset for storage of data for the service.
Aspect 2. The computing device of aspect 1, wherein each of the guard rows comprises at least a portion of a row of memory that is user unaccessable.
Aspect 3. The computing device of any one of aspects 1-2, wherein each of the guard rows comprises at least a portion of a row of memory that is not assigned for data storage for any service.
Aspect 4. The computing device of any one of aspects 1-3, wherein, to assign the guard rows, the one or more processors are configured to: assign at least a portion of a first row in a physical space of a memory as a first guard row; and assign at least a portion of a second row in the physical space of the memory as a second guard row, wherein the memory subset comprises memory cells between the first guard row and the second guard row.
Aspect 5. The computing device of any one of aspects 1-4, wherein the service comprises implementing a virtual machine.
Aspect 6. The computing device of any one of aspects 1-5, wherein only the portion of the memory subset is dedicated for storage of data for the service.
Aspect 7. The computing device of any one of aspects 1-6, wherein the one or more processors are configured to: receive a second memory assignment for the service; determine that the memory subset can accommodate storage of data for the second memory assignment; and dedicate another portion of the memory subset for the second memory assignment.
Aspect 8. The computing device of any one of aspects 1-7, wherein the one or more processors are configured to identify that the first memory assignment is not associated with memory shared with another service, wherein the memory subset is protected based on the identification.
Aspect 9. The computing device of any one of aspects 1-8, wherein the one or more processors are configured to identify the memory subset and the guard rows based on a mapping between a physical address associated with the service and physical memory rows.
Aspect 10. The computing device of any one of aspects 1-9, wherein the type of data includes sensitive data.
Aspect 11. The computing device of aspect 10, wherein the sensitive data includes personal data or financial data.
Aspect 12. A method for memory protection, comprising: receiving a first memory assignment for a service; determining, in response to receiving the first memory assignment, that the service is associated with a type of data; assigning guard rows adjacent to a memory subset to protect the memory subset based on the determination; and dedicating at least a portion of the memory subset for storage of data for the service.
Aspect 13. The method of aspect 12, wherein each of the guard rows comprises at least a portion of a row of memory that is user unaccessable.
Aspect 14. The method of any one of aspects 12-13, wherein each of the guard rows comprises at least a portion of a row of memory that is not assigned for data storage for any service.
Aspect 15. The method of any one of aspects 12-14, wherein assigning the guard rows includes: assigning at least a portion of a first row in a physical space of a memory as a first guard row; and assigning at least a portion of a second row in the physical space of the memory as a second guard row, wherein the memory subset comprises memory cells between the first guard row and the second guard row.
Aspect 16. The method of any one of aspects 12-15, wherein the service comprises implementing a virtual machine.
Aspect 17. The method of any one of aspects 12-16, wherein only the portion of the memory subset is dedicated for storage of data for the service.
Aspect 18. The method of any one of aspects 12-17, further comprising: receiving a second memory assignment for the service; determining that the memory subset can accommodate storage of data for the second memory assignment; and dedicating another portion of the memory subset for the second memory assignment.
Aspect 19. The method of any one of aspects 12-18, further comprising identifying that the first memory assignment is not associated with memory shared with another service, wherein the memory subset is protected based on the identification.
Aspect 20. The method of any one of aspects 12-19, further comprising identifying the memory subset and the guard rows based on a mapping between a physical address associated with the service and physical memory rows.
Aspect 21. The method of any one of aspects 12-20, wherein the type of data includes sensitive data.
Aspect 22. The method of aspect 21, wherein the sensitive data includes personal data or financial data.
Aspect 23. A non-transitory computer-readable medium having stored thereon instructions that, when executed by one or more processors, cause the one or more processors to perform operations according to any of aspects 1 to 22.
Aspect 24. An apparatus for memory protection, the apparatus including one or more means for performing operations according to any of aspects 1 to 22.

What is claimed is:

1. A computing device, comprising:
at least one memory; and
one or more processors coupled to the at least one memory and configured to:
receive a first memory assignment for a service;
determine, in response to receiving the first memory assignment, that the service is associated with a type of data;
assign guard rows adjacent to a memory subset to protect the memory subset based on the determination; and
dedicate at least a portion of the memory subset for storage of data for the service.

2. The computing device of claim 1, wherein each of the guard rows comprises at least a portion of a row of memory that is user unaccessable.

3. The computing device of claim 1, wherein each of the guard rows comprises at least a portion of a row of memory that is not assigned for data storage for any service.

4. The computing device of claim 1, wherein, to assign the guard rows, the one or more processors are configured to:
assign at least a portion of a first row in a physical space of a memory as a first guard row; and
assign at least a portion of a second row in the physical space of the memory as a second guard row, wherein the memory subset comprises memory cells between the first guard row and the second guard row.

5. The computing device of claim 1, wherein the service comprises implementing a virtual machine.

6. The computing device of claim 1, wherein only the portion of the memory subset is dedicated for storage of data for the service.

7. The computing device of claim 1, wherein the one or more processors are configured to:
receive a second memory assignment for the service;
determine that the memory subset can accommodate storage of data for the second memory assignment; and
dedicate another portion of the memory subset for the second memory assignment.

8. The computing device of claim 1, wherein the one or more processors are configured to identify that the first memory assignment is not associated with memory shared with another service, wherein the memory subset is protected based on the identification.

9. The computing device of claim 1, wherein the one or more processors are configured to identify the memory subset and the guard rows based on a mapping between a physical address associated with the service and physical memory rows.

10. The computing device of claim 1, wherein the type of data includes sensitive data.

11. The computing device of claim 10, wherein the sensitive data includes personal data or financial data.

12. A method for memory protection, comprising:
receiving a first memory assignment for a service;
determining, in response to receiving the first memory assignment, that the service is associated with a type of data;
assigning guard rows adjacent to a memory subset to protect the memory subset based on the determination; and
dedicating at least a portion of the memory subset for storage of data for the service.

13. The method of claim 12, wherein each of the guard rows comprises at least a portion of a row of memory that is user unaccessable.

14. The method of claim 12, wherein each of the guard rows comprises at least a portion of a row of memory that is not assigned for data storage for any service.

15. The method of claim 12, wherein assigning the guard rows includes:
assigning at least a portion of a first row in a physical space of a memory as a first guard row; and
assigning at least a portion of a second row in the physical space of the memory as a second guard row, wherein the memory subset comprises memory cells between the first guard row and the second guard row.

16. The method of claim 12, wherein the service comprises implementing a virtual machine.

17. The method of claim 12, wherein only the portion of the memory subset is dedicated for storage of data for the service.

18. The method of claim 12, further comprising:
receiving a second memory assignment for the service;
determining that the memory subset can accommodate storage of data for the second memory assignment; and
dedicating another portion of the memory subset for the second memory assignment.

19. The method of claim 12, further comprising identifying that the first memory assignment is not associated with memory shared with another service, wherein the memory subset is protected based on the identification.

20. The method of claim 12, further comprising identifying the memory subset and the guard rows based on a mapping between a physical address associated with the service and physical memory rows.

21. The method of claim 12, wherein the type of data includes sensitive data.

22. The method of claim 21, wherein the sensitive data includes personal data or financial data.

23. A computer-readable medium having instructions stored thereon, that when executed by one or more processors, cause the one or more processors to:
receive a first memory assignment for a service;
determine, in response to receiving the first memory assignment, that the service is associated with a type of data;
assign guard rows adjacent to a memory subset to protect the memory subset based on the determination; and
dedicate at least a portion of the memory subset for storage of data for the service.

24. An apparatus for memory protection, comprising:
means for receiving a first memory assignment for a service;
means for determining, in response to receiving the first memory assignment, that the service is associated with a type of data;
means for assigning guard rows adjacent to a memory subset to protect the memory subset based on the determination; and
means for dedicating at least a portion of the memory subset for storage of data for the service.
